(19) United States
(12) Patent Application Publication
(10) Pub. No.: US 2020/0127974 A1
(43) Pub. Date: Apr. 23, 2020

(54) CROSS-DOMAIN TRANSFER SYSTEM USING SHARED MEMORY

(71) Applicant: Owl Cyber Defense Solutions, LLC, Ridgefield, CT (US)

(72) Inventor: Salvatore Morlando, Easton, CT (US)

(21) Appl. No.: 16/166,825

(22) Filed: Oct. 22, 2018

(51) Int. Cl. H04L 29/06

(52) U.S. Cl. CPC H04L 63/0227; H04L 63/164; H04L 63/105; H04L 63/0209

(57) ABSTRACT

A one-way transfer system is disclosed using a shared memory. An input processor is coupled to an input interface and receives and processes input information from the input interface. The input processor is coupled to the shared memory so that information can be written to the shared memory but not read from the shared memory. The input processor writes processed input information to the shared memory. An output processor is coupled to the shared memory so that information can be read from the shared memory but not written to the shared memory. The output processor is coupled to the output interface and monitors the shared memory for new information, reads the new information, and forwards the new information to the output interface as output information. The output processor has no communications pathway to transfer any information to the input processor.

### FIELD

This disclosure relates generally to a cross-domain transfer system using shared memory, and, more particularly, to a cross-domain transfer system which passes data across a domain boundary by utilizing a shared memory which acts as a one-way transfer path so that information can be only written to the shared memory from one network domain and the same information can only be read from the shared memory in another separate network domain.

### BACKGROUND

Many organizations have processing and communication environments which include different networks subject to differing levels of security. Such environments may include a highly secure network used to communicate confidential or secret information, and one or more less secure networks that do not process confidential or secret information. Such highly secure networks may have strict limitations on the type of data that can be imported thereto or exported therefrom. In addition, the data within a highly secure network may be subject to differing security requirements.

In some cases, a one-way link is be used to transfer data. For example, a one-way link may receive data from a highly secure network (the source network) on an input and forward such data to a less secure network (the destination network) on an output, or vice versa. A prior art cross-domain solution system 80 is shown which includes a first client 10 coupled to a first network 20 in a first network domain 44 (the area to the left of dotted line 45). A send server 30 is also coupled to first network 20. The send server 30 is coupled to a receive server 50 via a one-way link 40. The receive server 50 is coupled to a second network 60 in a second network domain 46 (the area to the right of dotted line 45). A second client 70 is also coupled to second network 60. First network 20 is completely isolated from second network 60, except for the one-way transfer path provided by send server 30, one-way link 40, and receive server 50. Typically, the first network 20 has a different security classification than second network 60. To transfer information or files from the first client 10 to the second client 7one0, first client 10 initiates the transfer by forwarding the information or files to send server 30 (shown by arrow 15 in FIG. 1). This may be done using Transmission Control Protocol/Internet Protocol (TCP/IP) packets or User Datagram Protocol (UDP) packets, as described in detail in U.S. Pat. No. 8,139,581 to Ronald Mraz, et al., the disclosure of which is incorporated herein by reference in its entirety (“the '581 patent”). Send server 30 then forwards the information or files across the one-way link 40 to receive server 50 (shown by arrow 25 in FIG. 1). The one-way link 40 is a hardware-enforced one-way transmission channel which precludes any data (information or files) or signals of any kind from passing in the reverse direction (e.g., from receive server 50 to send server 30). The one-way link 40 is formed by use of an optical fiber coupled between a send-only interface card coupled to send server 30 and a receive-only interface card coupled to receive server 50. One particular type of hardware-enforced one-way link is shown in more detail in U.S. Pat. No. 8,068,415 B2 to Ronald Mraz, the disclosure of which is incorporated herein by reference in its entirety (“the '415 patent”). Finally, receive server 50 forwards the information or files to the second client 70 (shown by arrow 65 in FIG. 1). Although the use of an optical fiber coupled between a send-only interface card mounted in send server 30 and a receive-only interface card mounted in receive server 50 provides a high level of assurance that no path exists for any communications whatsoever from receive server 50 to send server 30, it precludes any ability to create a one-way link entirely within a single integrated circuit (i.e., only within silicon). This can impact, inter alia, the cost, speed, and size of the one-way link.

Accordingly, there is a need for a cross-domain transfer system which overcomes the foregoing problems.

### SUMMARY

In a first aspect, a one-way transfer system uses a shared memory. The one-way transfer system has an input interface for receiving input information. The one-way transfer system also has an input processor coupled to the input interface and configured to receive the input information from the input interface and to process the input information. The input processor is also coupled to the shared memory in a manner that allows information to be written to the shared memory and prevents information from being read from the shared memory. The input processor is further configured to write the processed input information to the shared memory. The one-way transfer system further has an output interface for transmitting output information. The one-way transfer system finally has an output processor coupled to the shared memory in a manner that allows information to be read from the shared memory and prevents information from being written to the shared memory. The output processor is also coupled to the output interface and configured to monitor the shared memory for new information, to read the new information, and to forward the new information to the output interface as output information. The output processor has no communications pathway to transfer any information to the input processor.

In a further embodiment, the shared memory may have a write enable pin and a read enable pin. The input processor may be connected to the write enable pin and may not be connected to the read enable pin. The output processor may be connected to the read enable pin and may not be connected to the write enable pin. In addition, the input processor may be configured to process the input information by filtering the input information based on predetermined criteria. Further, the input processor may be configured to process the input information by encrypting the input information and the output processor may be further configured to decrypt the new information before forwarding the decrypted new information to the output interface. Still further, the shared memory, the input processor, and the output processor may be provided on a single integrated circuit.

In a second aspect, a one-way transfer system uses a first shared memory and a second shared memory. The one-way transfer system has an input interface for receiving input information. The one-way transfer system also has an input processor coupled to the input interface and configured to receive the input information from the input interface and to process the input information. The input processor is also coupled to the first shared memory and the second shared memory in a manner that allows information to be selectively written to one of the first shared memory or the second shared memory based on predetermined criteria and prevents information from being read from the first shared memory and the second shared memory. The input processor is further configured to selectively write the processed input information to the first shared memory or the second shared memory. The one-way transfer system further has an output interface for transmitting output information. The one-way transfer system finally has an output processor coupled to the first shared memory and the second shared memory in a manner that allows information to be read from the first shared memory or the second shared memory and prevents information from being written to the first shared memory or the second shared memory. The output processor is also coupled to the output interface and configured to monitor the first shared memory and the second shared for new information, to read the new information, and to forward the new information to the output interface as output information. The output processor has no communications pathway to transfer any information to the input processor.

In a further embodiment, the first shared memory and the second shared memory each may have a write enable pin and a read enable pin. The input processor may be connected to the write enable pin of the first shared memory and to the write enable pin of the second shared memory. The input processor may not be connected to the read enable pin of the first shared memory and to the read enable pin of the second shared memory. The output processor may be connected to the read enable pin of the first shared memory and to the read enable pin of the second shared memory. Finally, the output processor may not be connected to the write enable pin of the first shared memory and to the write enable pin of the second shared memory. Further, the input processor may be configured to process the input information by filtering the input information based on predetermined criteria. Still further, the input processor may be configured to process the input information by encrypting the input information and the output processor may be further configured to decrypt the new information before forwarding the new information to the output interface. Also, the first shared memory, the second shared memory, the input processor, and the output processor may be provided on a single integrated circuit. In addition, the input information may comprise a first type of data packets and a second type of data packets, and the predetermined criteria may comprise a type of packet. Further, the first type of data packets may comprise Transmission Control Protocol/Internet Protocol packets and the second type of data packets may comprise User Datagram Protocol packets.

In a third aspect, a bidirectional transfer system uses a first shared memory and a second shared memory. The bidirectional transfer system has a first interface for receiving first input information and transmitting first output information. The bidirectional transfer system also has a first processor coupled to the first interface and configured to receive the first input information from the first interface and to process the first input information. The first processor is also coupled to the first shared memory in a manner that allows information to be selectively written to the first shared memory and prevents information from being read from the first shared memory. The first processor is also coupled to the second shared memory in a manner that allows information to be selectively read from the second shared memory and prevents information from being written to the second shared memory. The first processor is further configured to write the processed first input information to the first shared memory. The first processor is also configured to monitor the second shared for first new information, to read the first new information, and to forward the first new information to the first interface as first output information. The bidirectional transfer system further has a second interface for receiving second input information and transmitting second output information. The bidirectional transfer system finally has a second processor coupled to the first shared memory in a manner that allows information to be read from the first shared memory and prevents information from being written to the first shared memory. The second processor is also coupled to the second interface and configured to monitor the first shared memory for second new information, to read the second new information, and to forward the second new information to the second interface as second output information. The second processor is also coupled to the second shared memory in a manner that allows information to be selectively written to the second shared memory and prevents information from being read from the second shared memory. The second processor is also configured to receive the second input information from the second interface, to process the second input information, and to write the processed second input information to the second shared memory, the second processor having no other communications pathway with the first processor.

In a further aspect, the first shared memory and second shared memory each may have a write enable pin and a read enable pin. The first processor may be connected to the write enable pin of the first shared memory and to the read enable pin of the second shared memory. The first processor may not be connected to the read enable pin of the first shared memory and to the write enable pin of the second shared memory. The second processor may be connected to the read enable pin of the first shared memory and to the write enable pin of the second shared memory. The second processor may not be connected to the write enable pin of the first shared memory and to the read enable pin of the second shared memory. The first processor may be configured to process the first input information by filtering the first input information based on predetermined criteria. The first processor may be configured to process the first input information by encrypting the first input information and the second processor may be further configured to decrypt the second new information before forwarding the decrypted second new information to the second interface. The first shared memory, the second shared memory, the first processor, and the second processor may be provided on a single integrated circuit.

In a fourth aspect, a filter criteria storage system using a shared memory. The filter criteria storage system has an interface for receiving filter criteria information. The filter criteria storage system further has a processor coupled to the interface and configured to receive the filter criteria information from the interface and to process the filter criteria information. The processor is also coupled to the shared memory in a manner that allows information to be written to the shared memory and prevents information from being read from the shared memory. The processor is further configured to write the processed filter criteria information to the shared memory. The filter criteria storage system finally has a filter engine coupled to the shared memory in a manner that allows information to be read from the shared memory and prevents information from being written to the shared memory. The filter engine is configured to monitor the shared memory for new filter criteria information, to read the new filter criteria information, and to store the new filter criteria information in an internal memory.

In a further embodiment, the shared memory may have a write enable pin and a read enable pin. The processor may be connected to the write enable pin and may not be connected to the read enable pin and the filter engine may be connected to the read enable pin and may not be connected to the write enable pin. The processor may be configured to process the filter criteria information by validating that the filter criteria information conforms to predetermined criteria.

The features, functions, and advantages can be achieved independently in various embodiments of the present disclosure or may be combined in yet other embodiments in which further details can be seen with reference to the following description and drawings.

### BRIEF DESCRIPTION OF THE DRAWINGS

The following detailed description, given by way of example and not intended to limit the present disclosure solely thereto, will best be understood in conjunction with the accompanying drawings in which:

FIG. 1 is a block diagram of a prior art cross-domain solution;

FIG. 2 is a block diagram of a one-way link according to a first embodiment of the present disclosure;

FIG. 3 is a block diagram of an example application of the one-way link shown in FIG. 2;

FIG. 4 is a block diagram of a one-way link according to a second embodiment of the present disclosure;

FIG. 5 is a block diagram of a one-way link according to a third embodiment of the present disclosure; and

FIG. 6 is a block diagram of a one-way link according to a fourth embodiment of the present disclosure.

### DETAILED DESCRIPTION

In the present disclosure, like reference numbers refer to like elements throughout the drawings, which illustrate various exemplary embodiments of the present disclosure.

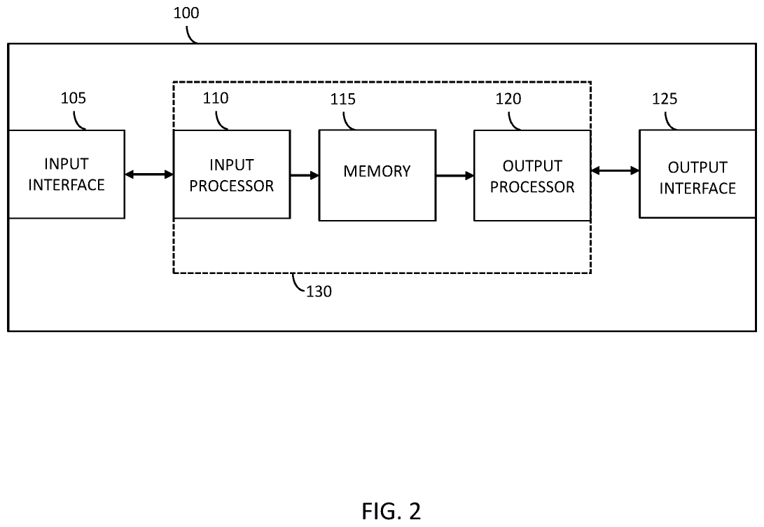

Referring now to the drawings and in particular to FIG. 2, a one-way link system 100 is shown in which a shared memory, i.e., memory 115, acts as the one-way transfer path for information passing from a first network domain to a second network domain. One-way link system 100 includes an input interface 105, an input processor 110, a memory 115, an output processor 120 and an output interface 125. The input interface 105 and output interface 125 are data communications interfaces, typically the same type, such as a network interface card (NIC), high-definition multimedia interface (HDMI), a data bus interface such as a small computer system interface (SCSI) or a PC Card bus interface, universal serial bus interface (USB), etc. Input processor 110 is connected to input interface 105 to receive any data (information) input to input interface 105. Input processor 110 is also connected to memory 115 in a write-only manner, i.e., in a manner which allows the data received at input interface 105 to be written into memory 115 and prevents input processor 110 from reading any data present in memory 115. For example, typically a memory chip includes both a write enable pin and a read enable pin. Memory 115 is preferably a volatile-type memory (e.g., dynamic RAM). The use of a volatile-type memory, which has faster read and write times than a non-volatile memory, provides a much faster throughput. In addition, memory 115 is of a type which is capable of being shared between two processors (either as installed or with additional circuits to implement such sharing). Memory 115 may be of the array type or may be a first-in first-out (FIFO) type. Input processor 110 may be connected to the write enable pin of memory 115 but not connected to the read enable pins thereof. In this way, input processor 110 cannot read from memory 115. Input processor 110 is configured to transfer data received at input interface 105 into memory 115. Input processor 110 may also process (e.g., filter based on predetermined criteria or encrypt) such received data prior to writing such data into memory 115.

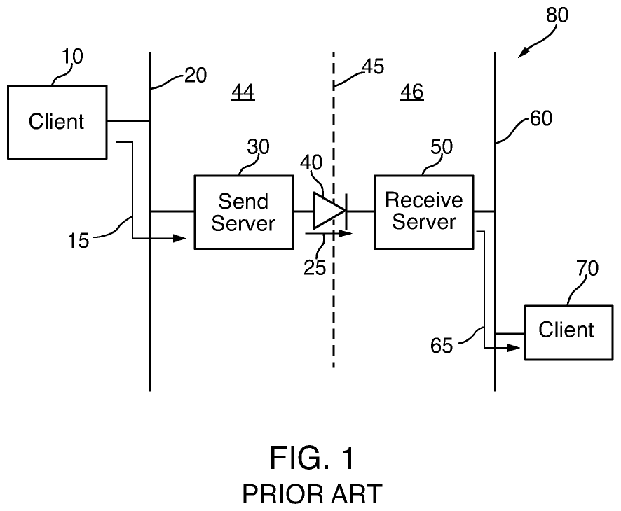

Output processor 120 is connected to memory 115 in a manner which allows output processor 120 to read information from memory 115 but without any ability to write data to memory 115. For example, output processor 120 may be connected to the read enable pin of memory 115 and not be connected to the write enable pin of memory 115. Output processor 120 is also connected to output interface 125. Output processor 120 is configured to monitor the memory 115 to detect when new data is stored therein, and, when the existence of new data is detected, output processor 120 is configured to read that data, to optionally process (e.g., decrypt) such data, and to forward such data (processed data, if processed) to output interface 125. During the memory write process, input processor 110 may, for example, change the state of a particular dedicated memory location in memory 115. Output processor 120 may thereafter identify the presence of new data by monitoring the memory 115 to identify when the state of that particular memory location has changed. No other connections are provided between input processor 110 and output processor 120, so the only path available to transfer information between input processor 110 and output processor 120 is via memory 115. Since input processor 110 can only write to memory 115 and output processor 120 can only read from memory 115, one-way link system 100 has a one-way transfer path from the input interface 105 to the output interface 125 and there is no possibility of any data or other information of any kind passing from output interface 125 to input interface 105 because there is no path at all for data to flow from output processor 120 to input processor 110. The use of a shared memory 115, instead of an optical fiber coupled between a send-only interface card coupled to a send server and a receive-only interface card coupled to a receive server, as in the prior art system shown in FIG. 1, has a number of benefits. Throughput is increased greatly because there is no need to serialize the data for transfer between the input processor 110 and output processor 120 since memory 115 can be written to and read from in parallel form. In addition, the use of a shared memory 115 will be more economical to implement given that less circuitry and no optical components may be required.

In one implementation of one-way link 101, each of the components 105, 110, 115, 120, 125 shown in FIG. 2 is a separate integrated circuit. In another implementation, a custom or semicustom integrated circuit may include all of the components 105, 110, 115, 120, 125 shown in FIG. 2. In yet another implementation, the input interface 105 and the output interface 125 may consist of separate integrated circuits, and the input processor 110, memory 115, and output processor 120 may be provided on a single chip (integrated circuit) 130 which may be a custom or semicustom integrated circuit, or a field programmable gate array (FPGA) circuit.

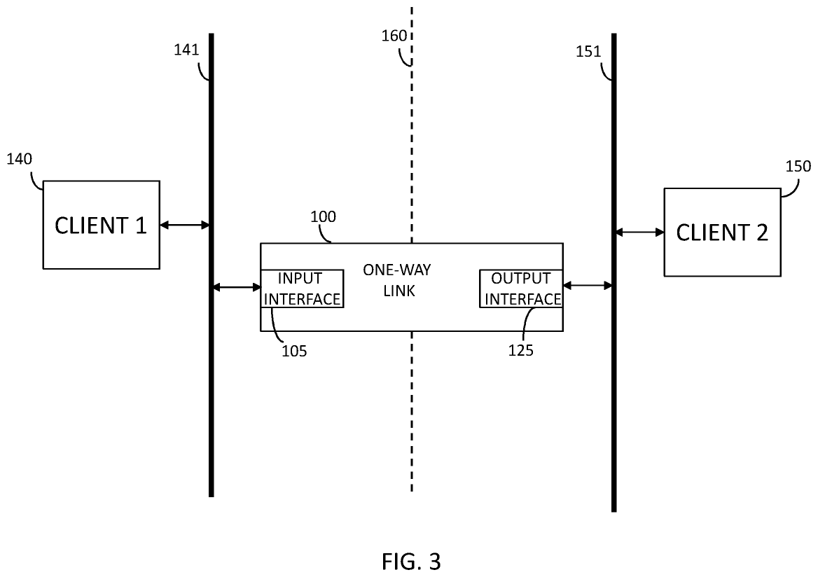

In operation, one-way link system 100 provides a secure way to transfer data from a first communications line (i.e., a line coupled to input interface 105) to a second communications line (i.e., a line coupled to output interface 125), while preventing any data from flowing from the second communications line (i.e., a line coupled to output interface 125) to the first communications line (i.e., a line coupled to input interface 105). Referring now to FIG. 3, an example application for one-way link 101 of FIG. 2 is shown. In particular, the input interface 105 of one-way link 101 is a network interface card and is coupled to a first network 141. The output interface 125 of one-way link 101 is also a network interface card and is coupled to a separate second network 151. No other communication links of any kind are provided between first network 141 and second network 151. A first client 140 is coupled to first network 141 (among other devices also coupled to first network 141) and a second client 150 is coupled to second network 151 (among other devices also coupled to second network 151). The first client 140 and first network 141 may be in a first network domain (the area to the left of dotted line 160) and the second client 150 and second network 151 may be in a second network domain (the area to the right of dotted line 160). In operation, first client 140 may transfer information to second client 150 by forwarding such information to the input interface 105 (network interface card) of one-way link 101. One-way link 101 forwards the data from the input interface 105 to the output interface 125, which then forwards such data to second client 150.

In some cases, the transfer from first client 140 to second client 150 may be done using TCP/IP protocol, with the input processor 110 and output processor 120 (FIG. 2) each configured to act as a TCP/IP proxy server as disclosed in U.S. Pat. No. 8,139,581 B1 to Ronald Mraz et al. (“the '581 Patent”, incorporated by reference in its entirety herein). The implementation of TCP/IP proxy servers provide an independent link layer protocol for one-way transfer that provides non-routable point to point communications with a true IP protocol break. With these properties, data packets or files cannot be accidentally routed in each of first network 141 and second network 151 and other protocols (such as printer protocols, etc.) will not route across the one-way data link. When the TCP server proxy in input processor 110 receives a file (or other information) from first client 140, the IP information normally carried in the data packet headers under the TCP/IP protocol is removed and replaced with pre-assigned point-to-point channel numbers, so that no IP information is transferred from input processor 110 to output processor 120. Instead, predetermined IP routes may be defined at the time of the configuration of the one-way link 101 in the form of channel mapping tables residing in the TCP server proxy associated with the input processor 110 and the TCP client proxy associated with the output processor 120. The input processor 110 then sends the files or data with the pre-assigned channel numbers to the output processor 120 via memory 115. Upon receipt of the files, the TCP client proxy in output processor 120 then maps the channel numbers from the received files or data to the corresponding predetermined IP address of a destination client (e.g., second client 150) to which the files or data are forwarded.

In other cases, the data transferred across one-way link 101 may be in the form of UDP packets, with the input processor 110 and output processor 120 each configured as a UDP socket, as also discussed in the '581 Patent. Further, the one-way link 101 may be configured to perform both TCP/IP protocol transfer and UDP transfer, as additionally discussed in the '581 Patent.

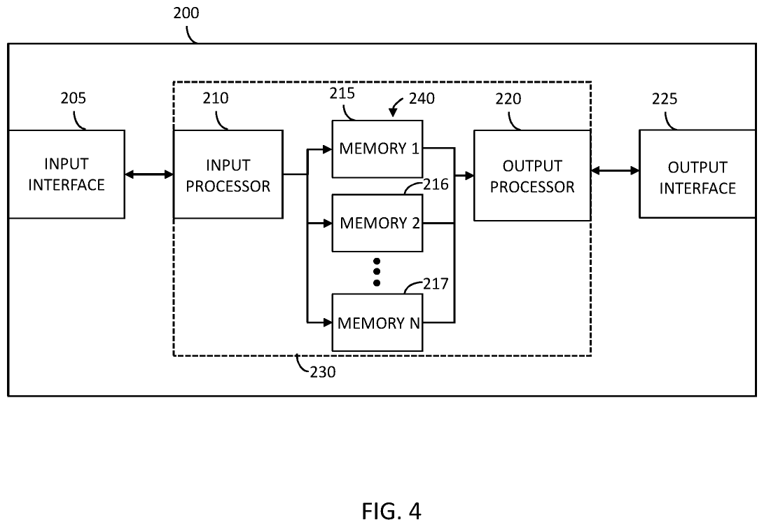

The use of shared memory as the one-way transfer path in a one-way link also provides the ability to provide parallel transfer paths from the input to output of such link. The use of parallel transfer paths enables faster throughput and/or the ability to provide different throughput speeds for different types of data. For example, UDP packets representing streaming video data may pass along a higher throughput channel while TCP/IP packets my pass along a slower throughput channel. Referring now to FIG. 4, a one-way link system 200 is shown having N parallel one-way transfer channels 240, including memories 215, 216, 217. One-way link system 200 is shown in FIG. 4 with N=3, but N may be any whole number greater than 2, depending on the particular implementation. For example, when a system is desired requires both UDP packets and TCP/IP packets to be forwarded across the one-way link, N would be chosen to be 2, with one memory dedicated to pass the UDP packets and the other memory dedicated to pass the TCP/IP packets. In this type of configuration, the memory dedicated to pass the UDP packets may be implemented to provide a higher throughput in certain further applications, e.g., when the UDP packets represent portions of streaming video signals. One-way link system 200 is otherwise similar to the one-way link system 100 shown in FIG. 2, with an input interface 205 coupled to an input processor 210. Input interface 205 is a data communications interface as discussed above with respect to input interface 105 in FIG. 2. Input processor 210, in turn is coupled to the shared memories 214, 216, 217 in a manner which allows input processor 210 to write to memories 215, 216, 217 and prevents input processor 210 to read from memories 215, 216, 217. Memories 215, 216, 217 are also connected to output processor 220 in a manner which allows output processor 220 to read from memories 215, 216, 217 and prevents output processor 220 from writing to memories 215, 216, 217. In turn, output processor 220 is coupled to an output interface 225. Output interface 225 is a data communications interface as discussed above with respect to output interface 125 in FIG. 2. No other connections are provided between input processor 210 and output processor 220, so the only path available to transfer information between input processor 210 and output processor 220 is via memories 215, 216, 217. Since input processor 210 can only write to memories 215, 216, 217 and output processor 220 can only read from memories 215, 216, 217 115, one-way link system 100 has a one-way transfer path from the input interface 205 to the output interface 225 and there is no possibility of any data or other information of any kind passing from output interface 225 to input interface 205 because there is no path at all for data to flow from output processor 220 to input processor 210.

The circuits that make up one-way link system 200 may be provided in separate discrete integrated circuits 205, 210, 215, 216, 217, 220, 225 or some or all of the functionality of such integrated circuits may be provided on a single chip which may be a custom or semicustom integrated circuit, or a field programmable gate array (FPGA) circuit. For example, a single chip 230 may be provided which includes the functionality of input processor 210, memories 215, 216, 217, and output processor 220.

In operation, the one-way link system 200 of FIG. 4 receives data (e.g., packets or files) on input interface 205 which are forwarded to input processor 210. Input processor 210 may processes such received information as necessary (including, for example, by applying an appropriate filter or encrypting the information) and then forwards such received (and optionally processed) information to one of the three (in this example system) memories 215, 216, 217 based on certain predetermined criteria (e.g., by packet type or distributed in a balanced manner to increase throughput). In the same manner as discussed with respect to the one-way link system 100 in FIG. 2, output processor 220 determines when new information is written in memories 215, 216, 217 and reads such new information (e.g., packets or files) and forwards such information to output interface 225 for appropriate transfer to a final destination.

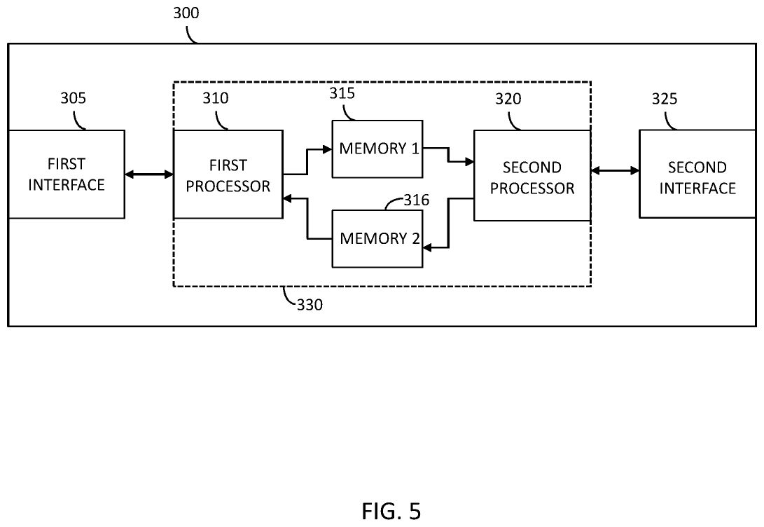

In some situations, it is desirable to have a bidirectional transfer system that employs parallel one-way links in opposite directions to each other. This type of system can be used to filter data passing in each direction, for example, and ensures that only filtered data is output from each interface. Such a system can be implemented using shared memory, as shown in FIG. 5. Referring now to FIG. 5, a bidirectional link system 300 includes a first interface 305, a first processor 310 coupled to first interface 305 and to two memories 315, 316. First interface 305 is a data communications interface as discussed above with respect to input interface 105 in FIG. 2. First processor 310 is coupled to memory 315 in a manner which allows first processor 310 to write to memory 315 and prevents first processor 310 from reading from memory 315. In addition, first processor 310 is coupled to memory 316 in a manner which allows first processor 310 to read from memory 316 and prevents first processor 310 from writing to memory 316. Second processor 320 is coupled to second interface 325 and to memories 315, 316. Second interface 325 is a data communications interface as discussed above with respect to output interface 125 in FIG. 2. Second processor 320 is coupled to memory 315 in a manner which allows second processor 320 to read from memory 315 and prevents second processor 320 from writing to memory 315. In addition, second processor 320 is coupled to memory 316 in a manner which allows first processor 310 to write to memory 316 and prevents second processor 320 from reading from memory 316. No other connections are provided between first processor 310 and second processor 320, so the only paths that are available to transfer information between first processor 310 and second processor 320 are via memories 315, 316. This provides more security than a conventional bidirectional link because all of the data passing from first interface 305 to second interface 325 may be filtered by first processor 310 and all the of the data passing from second interface 325 to first interface 305 may be filtered by second processor 320 (i.e., no data may pass between the first interface 305 and the second interface 325 without being filtered given the configuration of bidirectional link system 300).

The circuits that make up bidirectional link system 300 may be provided in separate discrete integrated circuits 305, 310, 315, 316, 320, 325 or some or all of the functionality of such integrated circuits may be provided on a single chip which may be a custom or semicustom integrated circuit, or a field programmable gate array (FPGA) circuit. For example, a single chip 330 may be provided which includes the functionality of first processor 310, memories 315, 316, and second processor 320.

First processor 310 is configured to receive input information (e.g., packets or files) from first interface 305, to process such information (e.g., to remove IP information and/or to filter the data), and to write such processed information to memory 315. In addition, first processor is configured to monitor the memory 316 for the presence of new information stored therein (as discussed above with respect to output processor 120 in FIG. 2), to read and process the new information (e.g., to add IP information), and to forward the processed new information to first interface 305 for output. First processor 310 is also configured to ensure that all information received from the first interface is maintained separately from the information read from memory 316.

Second processor 320 is configured to receive input information (e.g., packets or files) from second interface 325, to process such information (e.g., to remove IP information and/or to filter the data), and to write such processed information to memory 316. In addition, first processor is configured to monitor the memory 315 for the presence of new information stored therein (as discussed above with respect to output processor 120 in FIG. 2), to read and process the new information (e.g., to add IP information), and to forward the processed new information to second interface 325 for output. Second processor 320 is also configured to ensure that all information received from the second interface 325 is maintained separately from the information read from memory 315.

Bidirectional link system 300 allows information to flow in two directions between two different security domains and provides the ability to filter all information flowing between such security domains to ensure that no malware or other undesirable or unapproved information passes across the boundary between the two security domains. In addition, a protocol break may be provided so that IP information from one of the security domains is removed before the information is transmitted to the other of the security domains. The protocol break provides protection to the originating security domain since no IP information is passed outside such security domain.

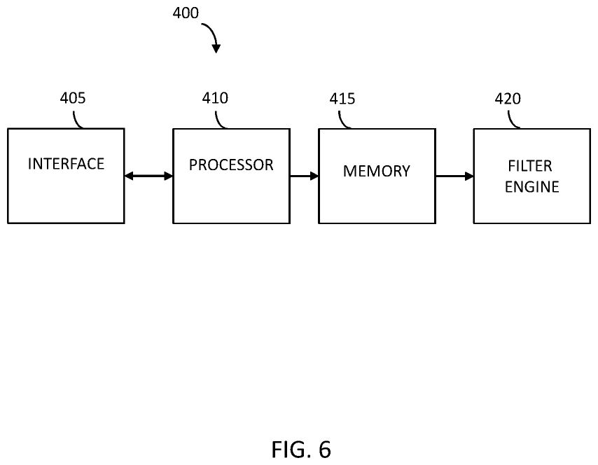

In some filtering applications, there is a need to securely receive and store filter criteria, i.e., the criteria used by a filter engine to filter information. A one-way link formed using shared memory can be used to secure such filter criteria. Referring now to FIG. 6, a filter criteria storage system 400 includes an input interface 405 that is coupled to a processor 410. Input interface 405 is a data communications interface as discussed above with respect to input interface 105 in FIG. 2. Processor 410, in turn, is coupled to a memory 415 in a manner which allows processor 410 to write to memory 415 and prevents processor 410 from reading from memory 415. Memory 415 is also coupled to a filter engine 430. Filter engine 420 is coupled to memory 415 in a manner which allows filter engine 420 to read from memory 415 and prevents filter engine 420 from writing to memory 415. Memory 415 is preferably a non-volatile memory so that the filter criteria information stored therein remains even when power to filter criteria storage system 400 is cut off. In operation, an external client transmits new filter criteria to filter criteria storage system 400 via input interface 405. Processor 410 receives the new filter criteria, processes the new filter criteria to validate that the new filter criteria is in an appropriate format (i.e., conforms to predetermined criteria), optionally encrypts the new filter criteria, and then stores the new filter criteria in memory 415. Filter engine 420 monitors the memory 415 for the presence of new filter criteria, reads the new filter criteria when present, optionally decrypts the new filter criteria (if encrypted by processor 410), and then stores the new filter criteria in an internal memory for use in performing filtering operations. No other connections are provided between processor 410 and filter engine 420, so the only path available to transfer information between processor 410 and filter engine 420 is via memory 415. Since processor 410 can only write to memory 415 and filter engine 420 can only read from memory 415, filter criteria storage system 400 has a one-way transfer path from the input interface 405 to the filter engine 420 and there is no possibility of any data or other information of any kind passing from filter engine 420 to input interface 405 because there is no path at all for data to flow from filter engine 420 to processor 410. Filter criteria storage system 400 provides a secure method of receiving and storing new filter criteria while at the same time ensuring that no other type of access is provided to filter engine 420 since only validated filter criteria can be passed across the one-way path formed by shared memory 415.

The various embodiments disclosed herein provide a flexible and economical way to transmit information across a security domain boundary. Although the present invention has been particularly shown and described with reference to the preferred embodiments and various aspects thereof, it will be appreciated by those of ordinary skill in the art that various changes and modifications may be made without departing from the spirit and scope of the invention. It is intended that the appended claims be interpreted as including the embodiments described herein, the alternatives mentioned above, and all equivalents thereto.

What is claimed is:

1. A one-way transfer system, comprising:
a shared memory;
an input interface for receiving input information;
an input processor coupled to the input interface and configured to receive the input information from the input interface and to process the input information, the input processor also coupled to the shared memory in a manner that allows information to be written to the shared memory and prevents information from being read from the shared memory, the input processor further configured to write the processed input information to the shared memory;
an output interface for transmitting output information; and
an output processor coupled to the shared memory in a manner that allows information to be read from the shared memory and prevents information from being written to the shared memory, the output processor also coupled to the output interface and configured to monitor the shared memory for new information, to read the new information, and to forward the new information to the output interface as output information, the output processor having no communications pathway to transfer any information to the input processor.

2. The one-way transfer system of claim 1, wherein the shared memory has a write enable pin and a read enable pin, and wherein the input processor is connected to the write enable pin and is not connected to the read enable pin and the output processor is connected to the read enable pin and is not connected to the write enable pin.

3. The one-way transfer system of claim 1, wherein the input processor is configured to process the input information by filtering the input information based on predetermined criteria.

4. The one-way transfer system of claim 1, wherein the input processor is configured to process the input information by encrypting the input information and the output processor is further configured to decrypt the new information before forwarding the decrypted new information to the output interface.

5. The one-way transfer system of claim 1, wherein the shared memory, the input processor, and the output processor are provided on a single integrated circuit.

6. A one-way transfer system, comprising:
a first shared memory;
a second shared memory;
an input interface for receiving input information;
an input processor coupled to the input interface and configured to receive the input information from the input interface and to process the input information, the input processor also coupled to the first shared memory and the second shared memory in a manner that allows information to be selectively written to one of the first shared memory or the second shared memory based on predetermined criteria and prevents information from being read from the first shared memory and the second shared memory, the input processor further configured to selectively write the processed input information to the first shared memory or the second shared memory;
an output interface for transmitting output information; and
an output processor coupled to the first shared memory and the second shared memory in a manner that allows information to be read from the first shared memory or the second shared memory and prevents information from being written to the first shared memory or the second shared memory, the output processor also coupled to the output interface and configured to monitor the first shared memory and the second shared memory for new information, to read the new information, and to forward the new information to the output interface as output information, the output processor having no communications pathway to transfer any information to the input processor.

7. The one-way transfer system of claim 6, wherein the first shared memory and the second shared memory each has a write enable pin and a read enable pin, and wherein the input processor is connected to the write enable pin of the first shared memory and to the write enable pin of the second shared memory, the input processor is not connected to the read enable pin of the first shared memory and to the read enable pin of the second shared memory, the output processor is connected to the read enable pin of the first shared memory and to the read enable pin of the second shared memory, and the output processor is not connected to the write enable pin of the first shared memory and to the write enable pin of the second shared memory.

8. The one-way transfer system of claim 6, wherein the input processor is configured to process the input information by filtering the input information based on predetermined criteria.

9. The one-way transfer system of claim 6, wherein the input processor is configured to process the input information by encrypting the input information and the output processor is further configured to decrypt the new information before forwarding the new information to the output interface.

10. The one-way transfer system of claim 6, wherein the first shared memory, the second shared memory, the input processor, and the output processor are provided on a single integrated circuit.

11. The one-way transfer system of claim 6, wherein the input information comprises a first type of data packets and a second type of data packets, and wherein the predetermined criteria comprises a type of packet.

12. The one-way transfer system of claim 11, wherein the first type of data packets comprises Transmission Control Protocol/Internet Protocol packets and the second type of data packets comprises User Datagram Protocol packets.

13. A bidirectional transfer system, comprising:
a first shared memory;
a second shared memory;
a first interface for receiving first input information and transmitting first output information;
a first processor coupled to the first interface and configured to receive the first input information from the first interface and to process the first input information, the first processor also coupled to the first shared memory in a manner that allows information to be selectively written to the first shared memory and prevents information from being read from the first shared memory, the first processor also coupled to the second shared memory in a manner that allows information to be selectively read from the second shared memory and prevents information from being written to the second shared memory, the first processor further configured to write the processed first input information to the first shared memory, the first processor also configured to monitor the second shared for first new information, to read the first new information, and to forward the first new information to the first interface as first output information;
a second interface for receiving second input information and transmitting second output information; and
a second processor coupled to the first shared memory in a manner that allows information to be read from the first shared memory and prevents information from being written to the first shared memory, the second processor also coupled to the second interface and configured to monitor the first shared memory for second new information, to read the second new information, and to forward the second new information to the second interface as second output information, the second processor also coupled to the second shared memory in a manner that allows information to be selectively written to the second shared memory and prevents information from being read from the second shared memory, the second processor also configured to receive the second input information from the second interface, to process the second input information, and to write the processed second input information to the second shared memory, the second processor having no other communications pathway with the first processor.

14. The bidirectional transfer system of claim 13, wherein the first shared memory and second shared memory each has a write enable pin and a read enable pin, and wherein the first processor is connected to the write enable pin of the first shared memory and to the read enable pin of the second shared memory, the first processor is not connected to the read enable pin of the first shared memory and to the write enable pin of the second shared memory, the second processor is connected to the read enable pin of the first shared memory and to the write enable pin of the second shared memory, and the second processor is not connected to the write enable pin of the first shared memory and to the read enable pin of the second shared memory.

15. The bidirectional transfer system of claim 13, wherein the first processor is configured to process the first input information by filtering the first input information based on predetermined criteria.

16. The bidirectional transfer system of claim 13, wherein the first processor is configured to process the first input information by encrypting the first input information and the second processor is further configured to decrypt the second new information before forwarding the decrypted second new information to the second interface.

17. The bidirectional transfer system of claim 13, wherein the first shared memory, the second shared memory, the first processor, and the second processor are provided on a single integrated circuit.

18. A filter criteria storage system, comprising:
a shared memory;
an interface for receiving filter criteria information;
a processor coupled to the interface and configured to receive the filter criteria information from the interface and to process the filter criteria information, the processor also coupled to the shared memory in a manner that allows information to be written to the shared memory and prevents information from being read from the shared memory, the processor further configured to write the processed filter criteria information to the shared memory; and
a filter engine coupled to the shared memory in a manner that allows information to be read from the shared memory and prevents information from being written to the shared memory, the filter engine configured to monitor the shared memory for new filter criteria information, to read the new filter criteria information, and to store the new filter criteria information in an internal memory.

19. The filter criteria storage system of claim 18, wherein the shared memory has a write enable pin and a read enable pin, and wherein the processor is connected to the write enable pin and is not connected to the read enable pin and the filter engine is connected to the read enable pin and is not connected to the write enable pin.

20. The filter criteria storage system of claim 18, wherein the processor is configured to process the filter criteria information by validating that the filter criteria information conforms to predetermined criteria.
